(19) United States
(12) Patent Application Publication
(10) Pub. No.: US 2004/0108991 A1
(43) Pub. Date: Jun. 10, 2004

(54) Cushion for an overhead LCD monitor in combination with a DVD player in an automobile

(76) Inventor: Steven Chang, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/309,064

(22) Filed: Dec. 4, 2002

(51) Int. Cl. G09G 5/00

(52) U.S. Cl. 345/156; 345/905

(57) ABSTRACT

A cushion for an overhead LCD monitor in combination with a DVD player includes four springs each having a first end adapted to be securely connected to a corresponding one of the extensions of the carrier. A seat is adapted to be securely mounted on the base and connected to the second end of the spring so that the carrier is supported by the spring to be separate from the base.

### CROSS REFERENCE

This is a continuation in part (CIP) of the application entitled OVERHEAD LCD MONITOR IN COMBINATION WITH A DVD PLAYER FOR A VEHICLE and filed on Jan. 4, 2002 with the application Ser. No. 10/038,938 by the same applicant. The content of the application is hereinafter incorporated.

### BACKGROUND OF THE INVENTION

1. Field of the Invention

The present invention relates to a cushion for an overhead LCD monitor in combination with a DVD player in an automobile, and more particularly to a cushion to absorb shocks from the automobile so as to maintain smooth running of the DVD player and quality of the LCD monitor.

2. Description of Related Art

A liquid crystal display (LCD) in combination with a DVD player has been available in the market for years. Normally, the user places the combination of the LCD and the DVD player on top of a table. However, some users mount the combination on the ceiling of a car, especially a sport utility vehicle (SUV). Therefore, the driver and the passenger(s) may enjoy not only high quality music but also images after a long, tough journey deep into a remote area. As we all know, the remote area is a place where not many people have been and naturally, the road condition is not very pleasant, not only to the driver, but also for the passenger(s). Especially, when the vehicle is running over a rough terrain and the LCD or the DVD player is running, there is a reasonably high possibility that the LCD or the DVD player will have malfunction.

To overcome the shortcomings, the present invention tends to provide an improved cushion to mitigate and obviate the aforementioned problems.

### SUMMARY OF THE INVENTION

The primary objective of the present invention is to provide an improved cushion to the overhead LCD monitor in combination with a DVD player in an automobile such that the LCD or the DVD player is able to run smoothly.

Other objects, advantages and novel features of the invention will become more apparent from the following detailed description when taken in conjunction with the accompanying drawings.

### BRIEF DESCRIPTION OF THE DRAWINGS

FIG. 1 is a schematic bottom view of the overhead LCD monitor in combination with a DVD player which is adapted on a vehicle ceiling;

FIG. 2 is a schematic top view of the overhead LCD monitor in combination with a DVD player in FIG. 1;

FIG. 3 is an exploded perspective view of the cushion in combination with parts of the overhead LCD monitor in combination with a DVD player; and

FIG. 4 is a schematic view showing the vibration after the cushion is mounted on the overhead LCD monitor in combination with a DVD player.

### DETAILED DESCRIPTION OF THE PREFERRED EMBODIMENT

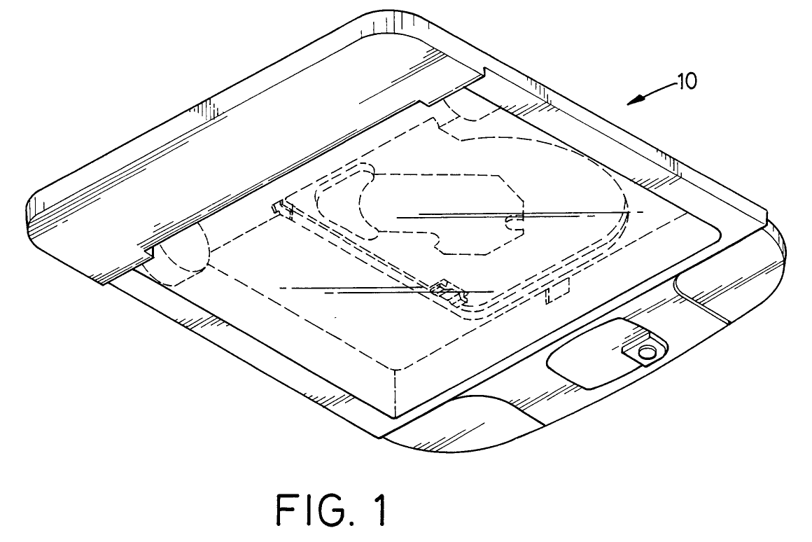

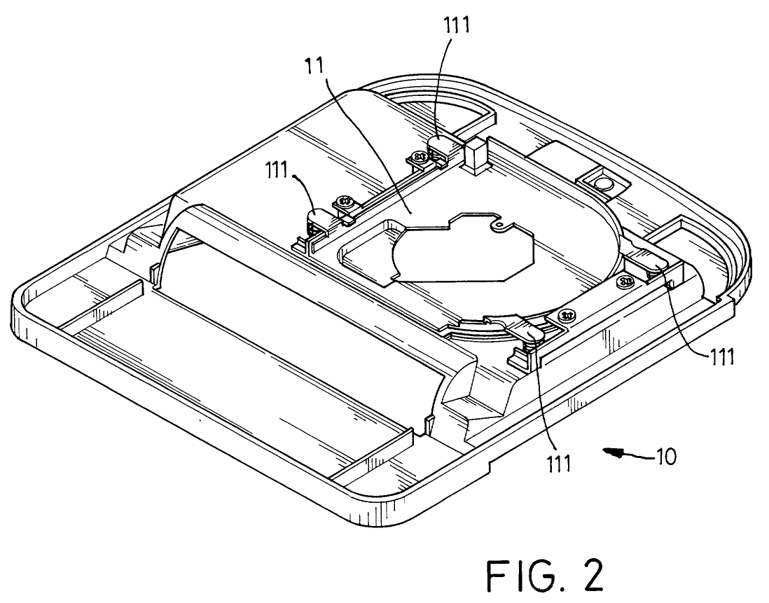

With reference to FIGS. 1 and 2, an overhead LCD monitor in combination with a DVD player in an automobile is mounted in a base (10). The base (10) is securely engaged with a ceiling of the automobile. The base (10) has a carrier (11) to be connected to the base (10) and engaged with the ceiling of the automobile. The carrier (11) carries the overhead LCD monitor in combination with a DVD player when the assembly is finished.

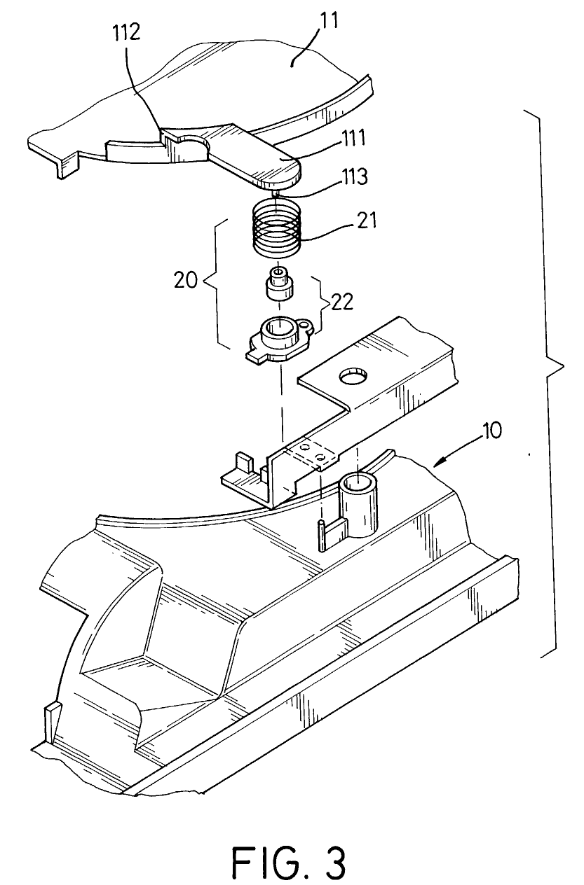

With reference to FIG. 3 and still taking FIG. 2 for reference, the carrier (11) has four extensions (111) each laterally extending out from the carrier (11) except an upright part (112) that connects the extension (111) to the carrier (11). Each extension (111) has a guiding post (113) extending downward and a cushion (20) corresponding to the extension (111) and having the guiding post (113) extending through the cushion (20).

The cushion (20) includes a spring (21) and a seat (22). One end of the spring (21) engages with a bottom face of a corresponding one of the extensions (111) and the other end of the spring (21) engages with the seat (22) which is securely mounted on a top face of the base (10).

Because the carrier (11) is separate from the base (10), the spring (21) sandwiched between the bottom face of the corresponding extension (111) and the seat (22) supports the carrier (11) on top of the base (10).

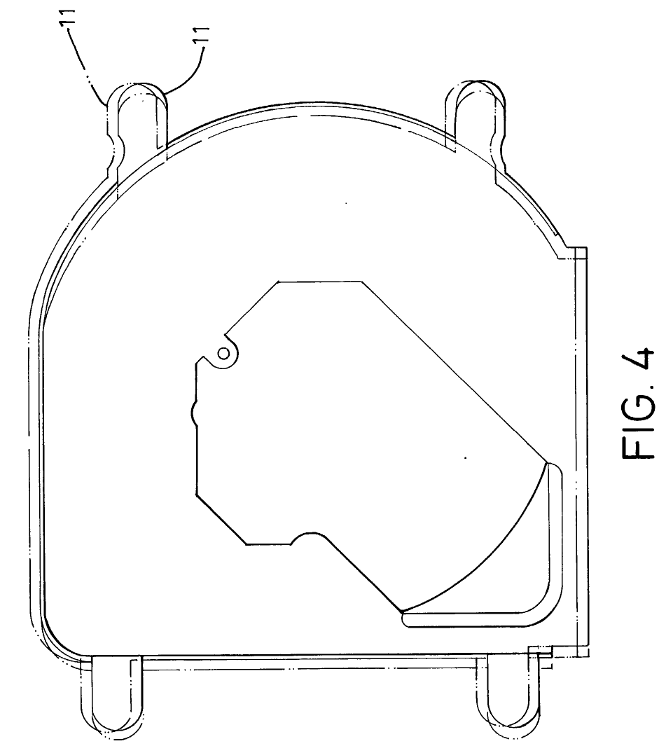

That is, the spring (21) supports the weight of the carrier (11) on top of the base (10). Thus, as shown in FIG. 4, when the vehicle is moving, the base (10) moves accordingly. However, due to the spring (21), the shock from the ground to the carrier (11) will be absorbed by the spring (21) and the overhead LCD monitor in combination with a DVD player will run smoothly. The dashed lines in FIG. 4 shows that the carrier (11) will also move as the vehicle moves. However, the movement of the carrier (11) is mild because of the spring (21).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cushion for an overhead LCD monitor in combination with a DVD player having a base adapted to be securely mounted on a vehicle ceiling and a carrier on top of the base to receive therein the overhead LCD monitor in combination with the DVD player, the carrier having four extensions laterally extending out of the base, the cushion comprising:
four springs each having a first end adapted to be securely connected to a corresponding one of the extensions of the carrier and a second end; and
a seat adapted to be securely mounted on the base and connected to the second end of the spring,
whereby the carrier is supported by the spring to be separate from the base.
